(19) United States
(12) Patent Application Publication
(10) Pub. No.: US 2025/0360721 A1
(43) Pub. Date: Nov. 27, 2025

(54) INK CONTAINER

(71) Applicant: CANON KABUSHIKI KAISHA, Tokyo (JP)

(72) Inventor: MASASHI ISHIKAWA, Tokyo (JP)

(21) Appl. No.: 19/203,355

(22) Filed: May 9, 2025

(30) Foreign Application Priority Data
May 21, 2024 (JP) 2024-082511

(51) Int. Cl. B41J 2/175; B32B 27/08; B32B 27/32; B32B 27/34; B32B 27/36

(52) U.S. Cl. CPC B41J 2/17553; B32B 27/08; B32B 27/32; B32B 27/34; B32B 27/36; B32B 2272/00; B32B 2307/414; B32B 2307/7376; B32B 2439/46

(57) ABSTRACT

The present disclosure includes a recycled plastic material and an object of the present disclosure is to provide an ink container excellent in ink resistance. In other words, the present disclosure can contribute to realization of a sustainable society such as a decarbonized/circular society. In order to realize this, an ink container accommodating an ink to be supplied to an inkjet printing apparatus includes an ink accommodating unit formed of a plurality of layers and configured to accommodate the ink and an ink supply unit configured to supply the ink in the ink accommodating unit to the outside of the ink accommodating unit. Further, at least one layer not in contact with the ink among the plurality of layers includes a recycled plastic material.

### BACKGROUND OF THE INVENTION

### Field of the Invention

The present disclosure relates to an ink container and more specifically relates to an ink container whose ink accommodating unit is formed of a member made by laminating a plurality of film sheets.

### Description of the Related Art

An ink pack is known as an ink container of this kind. An ink pack disclosed in Japanese Patent Laid-Open No. 2004-148705, for example, includes an aluminum alloy layer, and on one side of the aluminum alloy layer, an adhesive layer and a nylon layer (outer surface layer) are laminated. Further, on the other side of the aluminum alloy layer, an adhesive layer, a polyethylene terephthalate layer, an adhesive layer, and a polypropylene layer (inner surface layer) are laminated in this order. In such an ink pack, ink resistance improves because of the inner surface layer which is the polypropylene layer. Furthermore, gas penetration is interrupted by an intermediate layer which is the aluminum alloy layer, and the ink pack is less likely to break because of the outer surface layer which is the nylon layer.

These days, a product using a recycled plastic material is demanded because of a request or the like for the realization of a sustainable society such as a decarbonized/circular society. However, the recycled plastic material is generally deteriorated because of heat history in a case of molding and a stress, heat, light, a solvent or the like in a case of the use and is less resistant to an ink compared with a virgin material. Incidentally, in regard to ink resistance, it can be said that a material which is easily deteriorated by a solvent contained in an ink is less resistant to the ink. For example, polyethylene is deteriorated not only by sunlight but also by ultraviolet rays emitted by a fluorescent lamp. If energy such as heat, ultraviolet rays, or the like acts on a polymer, a radical is generated and bonds to oxygen in the air to produce a peroxide. A molecular chain of the polymer is broken by the peroxide and the molecular weight of the polymer becomes small. Then, in general, if the molecular weight is small, ink resistance deteriorates (decreases). Thus, there is apprehension that ink resistance of a recycled plastic material having long thermal history of molding and that of a recycled plastic material having history of exposure to ultraviolet rays decrease.

### SUMMARY OF THE INVENTION

Then, an object of the present disclosure is to provide an ink container excellent in ink resistance even though a recycled plastic material is used for the ink container.

In an aspect of the present disclosure, there is provided an ink container accommodating an ink to be supplied to an inkjet printing apparatus, the ink container inclusing: an ink accommodating unit formed of a plurality of layers and configured to accommodate the ink; and an ink supply unit configured to supply the ink in the ink accommodating unit to an outside of the ink accommodating unit, wherein at least one layer not in contact with the ink among the plurality of layers includes a recycled plastic material.

Further features of the present invention will become apparent from the following description of exemplary embodiments with reference to the attached drawings.

### BRIEF DESCRIPTION OF THE DRAWINGS

FIG. 1 is a schematic perspective view of an inkjet printing apparatus in which an ink pack of the present disclosure is installed;

FIG. 2A is a schematic perspective view of an ink pack of a first embodiment, and

FIG. 2B is a cross-sectional view of a film of the first embodiment;

FIG. 3 is a cross-sectional view of a film used for an ink pack of a second embodiment;

FIG. 4 is a cross-sectional view of a film used for an ink pack of a third embodiment;

FIGS. 5A to 5C are a schematic perspective view, a top view, and a cross-sectional view taken along the line A-A of an ink supply unit of a fourth embodiment; and

FIG. 6 is a cross-sectional view of a film used for an ink pack of a fifth embodiment.

### DESCRIPTION OF THE EMBODIMENTS

Embodiments are described below in detail with reference to the attached drawings. Incidentally, the embodiments described below are not purported to limit the disclosure of the claims. The embodiments describe a plurality of features, but not all of these plurality of features are indispensable for the disclosure, and the plurality of features may be optionally combined. Further, in the attached drawings, the same reference numeral may be assigned to the same or a similar constituent, and an overlapping description may be omitted.

### First Embodiment

Embodiments to implement a technique of the present disclosure are described below with reference to the drawings. Incidentally, the embodiments described below are not purported to limit the invention of the claims, and not all combinations of features described in the embodiments are indispensable for a solution of the invention.

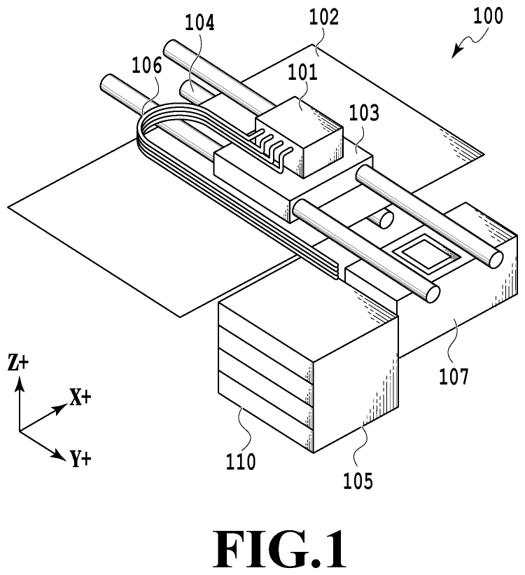

FIG. 1 is a schematic perspective view of an inkjet printing apparatus 100 in accordance with the present embodiment. As illustrated in FIG. 1, the inkjet printing apparatus 100 includes an ink ejection head 101, a printing sheet 102, a carriage 103, a conveying roller 104, an ink supply unit 105, an ink supply tube 106, and a recovery unit 107.

The inkjet printing apparatus 100 repeats a reciprocal movement (main scanning) of the ink ejection head 101 and each predetermined amount of conveyance (sub scanning) of the printing sheet 102 which is a print medium. A letter, symbol, image or the like are printed by making the ink ejection head 101 selectively eject inks of multiple colors in synchronization with these movements so that the inks land on the printing sheet 102 which is a print medium. As an example of the inkjet printing apparatus 100, for example, an inkjet printer is given. The print medium may use various materials and forms such as paper, cloth, an optical disc label surface, a plastic sheet, an OHP sheet, and an envelope.

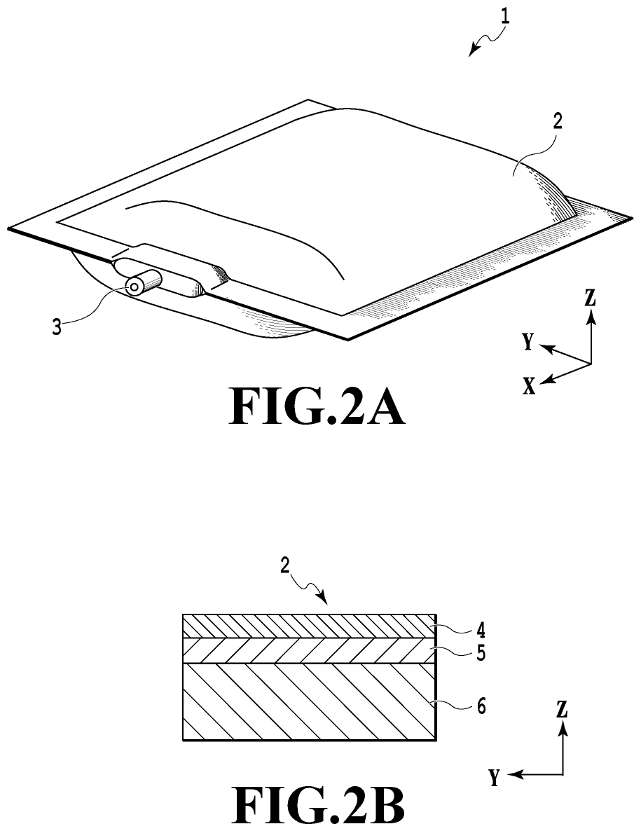

The ink ejection head 101 is installed in the carriage 103 which is supported by two guide rails in a free-to-slide manner and which reciprocally moves in a straight line along the guide rails with a driving unit (not illustrated) such as a motor. The printing sheet 102 is conveyed by the conveying roller 104 which is a conveying unit in a direction which is orthogonal to a moving direction of the carriage 103 so that the printing sheet 102 is opposed to an ink ejection surface of the ink ejection head 101. The ink ejection head 101 has a plurality of nozzle arrays to eject inks of different colors as a plurality of ink ejection units. A plurality of individual ink packs 1 (see FIG. 2A) having an ink leading-out member to lead an ink out are mounted on the ink supply unit 105 in such a way that the ink packs 1 correspond to the colors of inks ejected from the ink ejection head 101. In the present embodiment, four ink packs 1 which accommodate inks of cyan (C), magenta (M), yellow (Y), and black (K), respectively are installed in the ink supply unit 105. The four ink packs 1 are the same in size, but, for example, the ink pack 1 for the black ink may be larger than the ink packs 1 for the inks of the other colors. Further, a mode to install the ink ejection head 101 in the carriage 103 may have a configuration in which attaching/detaching can be easily performed or a configuration in which the ink ejection head 101 is fixedly arranged on the carriage 103.

The ink supply unit 105 is connected to the ink ejection head 101 with a plurality of the ink supply tubes 106 respectively corresponding to the colors of the inks. The inks of the respective colors accommodated in the ink packs 1 can be independently supplied to the nozzle arrays of the ink ejection head 101 by installing the ink packs 1 (see FIG. 2A) inside the ink supply unit 105. In a non-printing area which is an area in the range of a reciprocal movement of the ink ejection head 101 and out of the range of passage of the printing sheet 102, the recovery unit 107 is arranged so that the recovery unit 107 opposes the ink ejection surface of the ink ejection head 101.

The recovery unit 107 has a cap unit configured to cap the ink ejection surface of the ink ejection head 101, a suction mechanism configured to forcefully suck an ink in a state where the ink ejection surface is capped, and a cleaning blade configured to wipe soiling in the ink ejection surface or the like. The suction operation mentioned above is performed by the recovery unit 107 before a printing operation of the inkjet printing apparatus 100. In this way, even if this inkjet printing apparatus 100 is operated after left for a long time, it is possible to remove a residual bubble in the ink ejection head 101 and a thickening ink near an ejection opening or either one of these as a result of the recovery unit 107 performing the recovery operation. An ejecting characteristic of the ink ejection head 101 is thereby maintained. As mentioned above, the inkjet printing apparatus 100 has a function of introducing inks from the ink packs 1 and ejecting the inks.

FIG. 2A is a perspective view schematically illustrating an ink pack 1 in accordance with one embodiment, and FIG. 2B is a cross-sectional view of a film of an ink accommodating unit 2 constituting the ink pack 1. With reference to FIG. 2A, the ink pack 1 is formed to have the ink accommodating unit 2 having a film including a plurality of resin layers and an ink supply unit 3 configured to supply an ink to the inkjet printing apparatus 100. The ink supply unit 3 is designed to supply an ink to the inkjet printing apparatus 100, and a check valve is provided to the ink supply unit 3 to prevent back-flow of an ink from the outside of the ink supply unit 3 to the inside. The ink pack 1 is formed by performing thermal welding on a circumference portion of the film of the ink accommodating unit 2 and on an interface between the film and the ink supply unit 3 in the ink pack 1. The ink accommodating unit 2 is flexible. The shape of the ink accommodating unit 2 may be a pillow bag which is formed by bonding two films or a gusseted bag with a gusset on a side portion formed by folding and bonding one film. In the present embodiment, the shape of the pillow bag is described.

Here, illustrated directions are described below. In the present specification, a longitudinal direction of the ink pack 1 is referred to as an X direction (length direction), a planar direction orthogonal to the length direction is referred to as a Y direction (width direction), and a direction orthogonal to the X and Y directions is referred to as a Z direction (thickness direction). In regard to the X direction, a direction of a side on which the ink pack 1 is mounted on the ink supply unit 105 is a +X direction. In regard to the Y direction, a left side direction as viewed from the direction of the side on which the ink pack 1 is mounted on the ink supply unit 105 is a −Y direction.

With reference to FIG. 2B, the film of the ink accommodating unit 2 has an outer layer 4, an intermediate layer 5, and an inner layer 6. The layer configurations of the film are not limited to this, but may be formed in the range of the total thickness of 0.1 to 0.5 mm in consideration of the strength and flexibility of the ink pack 1, the characteristic of an ink to be accommodated, the use of recycled plastic described below, and the like. In the present embodiment, the outer layer 4 is formed of polyethylene terephthalate (PET film; a thickness of 0.03 mm) excellent in mechanical strength and heat resistance. The intermediate layer 5 is formed of nylon (a thickness of 0.03 mm) which is less likely to break. The inner layer 6 is formed of polyethylene (a thickness of 0.08 mm) which excels in ink resistance, has a low melting temperature, and is easy to perform thermal wielding on.

The intermediate layer 5 is a nylon film including a recycled plastic material. The intermediate layer 5 is composed of a mixed material which is a mixture of the recycled plastic material and a virgin material and contains 50% of the recycled plastic material. This content may be selected within the range of preferably 25% to 80% depending on the specifications or the like of an ink container to be formed.

As mentioned above, according to the present embodiment, layers of the ink accommodating unit 2 are formed in a state where the intermediate layer 5 is sandwiched between the outer layer 4 and the inner layer 6. The intermediate layer 5 including the recycled plastic material can be thereby made into a layer which is not in contact with an ink and is not directly contacted from the outside, and an ink container excellent in ink resistance can be made despite the use of the recycled plastic material. Incidentally, in regard to the intermediate layer 5 including the recycled plastic material, the nylon film is given as an example of a material including the recycled plastic material but is not limited to this, and other materials may be used.

In the present embodiment, the recycled plastic material may be a post-consumer material (PCR material) or a pre-consumer material or a mixed material which is a mixture of both. The post-consumer material (PCR material) is a material obtained by collecting and reusing plastic products such as waste articles after circulation in the market. The PCR material may be thermoplastic plastic prepared from waste industrial plastic. The pre-consumer material is a material obtained by collecting and reusing waste plastic produced in a manufacturing step before circulation in the market. For example, the pre-consumer material may be thermoplastic plastic prepared from offcuts re-processed in a factory of a processor after the offcuts are pre-processed by molding and extrusion in the same factory or a molded article which is rejected.

In the present embodiment, the intermediate layer 5 is composed of one layer, but the intermediate layer may be composed of a plurality of layers made of different materials or of a plurality of layers made of an identical material or may partly include the recycled plastic material. Further, it is preferable from the perspective of strength that a layer gap between the intermediate layer 5 and the outer layer 4 is adhered with an adhesive and that a layer gap between the intermediate layer 5 and the inner layer 6 is adhered with an adhesive, but an configuration in which part of or all of the layer gaps are not adhered may be used.

### Second Embodiment

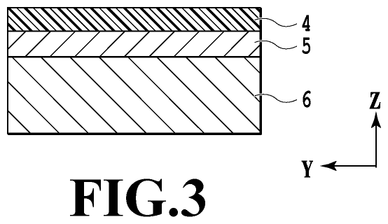

FIG. 3 is a cross-sectional view schematically illustrating a layer configuration of the film of the ink accommodating unit 2 in accordance with a second embodiment of the present disclosure. In the present embodiment, the outer layer 4 is formed of a polyethylene terephthalate film including the recycled plastic material. The content of the recycled plastic material is 50%. The intermediate layer 5 is formed of nylon (a thickness of 0.03 mm), and the inner layer 6 is formed of polyethylene (a thickness of 0.08 mm).

According to the present embodiment, recycled plastic can be used for a layer which an ink does not directly contact by forming the outer layer 4 of the mixed material which is a mixture of the recycled plastic material and the virgin material, and an inspection for a defect in outer appearance such as whitening which can occur if the recycled material is formed can be easily conducted. An ink container excellent in ink resistance can be made thereby despite the use of the recycled plastic material for a film of the ink container. Incidentally, the outer layer 4 including the recycled plastic material is not limited to the polyethylene terephthalate film but may be made of other materials.

### Third Embodiment

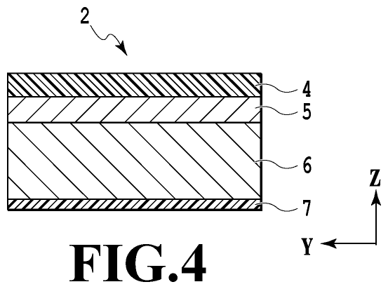

FIG. 4 is a cross-sectional view schematically illustrating a layer configuration of the ink accommodating unit 2 in accordance with a third embodiment of the present disclosure. In the present embodiment, the recycled plastic material is used for the inner layer 6. In other words, the inner layer 6 is formed of a polyethylene film including the recycled plastic material. A protective layer 7 which is formed of the same virgin material as that of the inner layer 6, namely polyethylene is provided to the inside (a side which is to be in contact with an ink) of the inner layer 6. The outer layer 4 is formed of a polyethylene terephthalate film, and the intermediate layer 5 is formed of nylon. The thickness of the protective layer 7 is a thickness realized by a smaller amount of the virgin material than the amount of the virgin material which is reduced by using the recycled plastic material for the inner layer 6. Specifically, if the thickness of the inner layer 6 is 0.08 mm and the content of the recycled plastic material is 50%, the protective layer 7 has only to be 0.04 mm or less in thickness. In the present embodiment, the protective layer 7 has a thickness of 0.01 mm in order to suppress the amount of the virgin material to be used. Incidentally, the material for the inner layer 6 including the recycled plastic material is not limited to polyethylene but may be other materials.

According to the third embodiment of the present disclosure, the recycled plastic material is included in the inner layer 6, but because of the presence of the protective layer 7, the inner layer 6 can avoid directly contacting an ink. An ink container excellent in ink resistance can be thereby made despite the use of the recycled plastic material for the film of the ink container.

### Fourth Embodiment

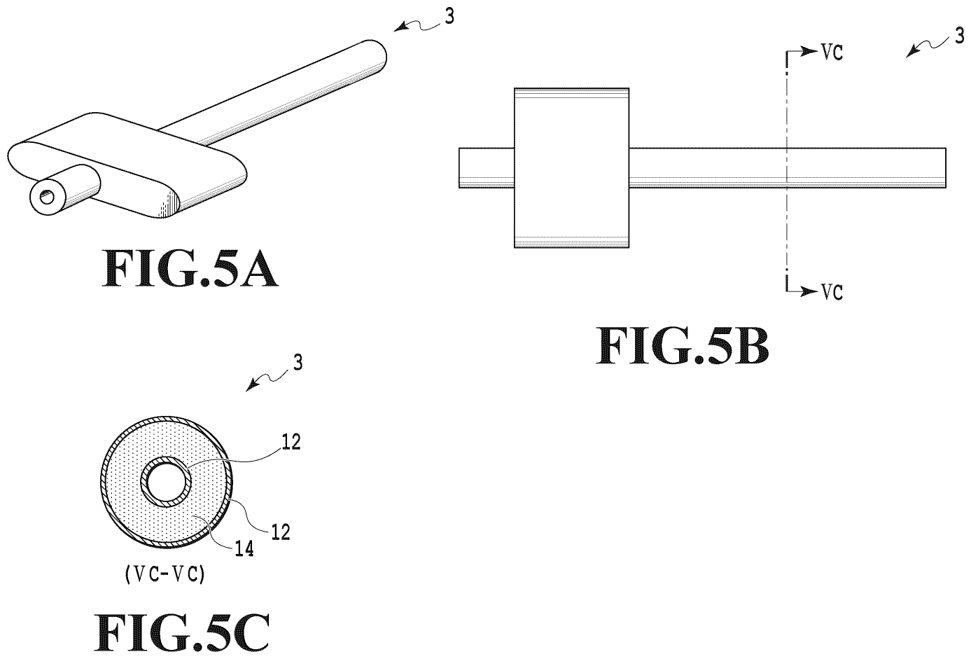

FIGS. 5A to 5C are diagrams schematically illustrating the ink supply unit 3 of the ink pack 1 in accordance with a fourth embodiment of the present disclosure. FIG. 5A is a perspective view of the ink supply unit 3. FIG. 5B is a plan view of the ink supply unit 3. FIG. 5C is a cross-sectional view of the ink supply unit 3 taken along the line VC-VC of FIG. 5B. In the present embodiment, as shown in FIG. 5C, a supply tube of the ink supply unit 3 is formed in a three-layered structure. In other words, an inner layer which is to be directly in contact with an ink passing through the supply tube and an outer layer forming the outside of the tube are a protective layer 12, and this protective layer 12 is formed by coating a surface of the tube with a silicone (e.g., organo-modified silicone) liquid agent which is highly resistant to an ink and heating and drying the silicone liquid agent. Then, an intermediate layer 14 is formed of resin including the recycled plastic material. Here, compared with the ink accommodating unit 2, the ink supply unit 3 uses a larger amount of plastic, the amount of the recycled plastic material to be used can be increased. In the present embodiment, an ink container excellent in ink resistance can also be made while the recycled plastic material is used.

### Fifth Embodiment

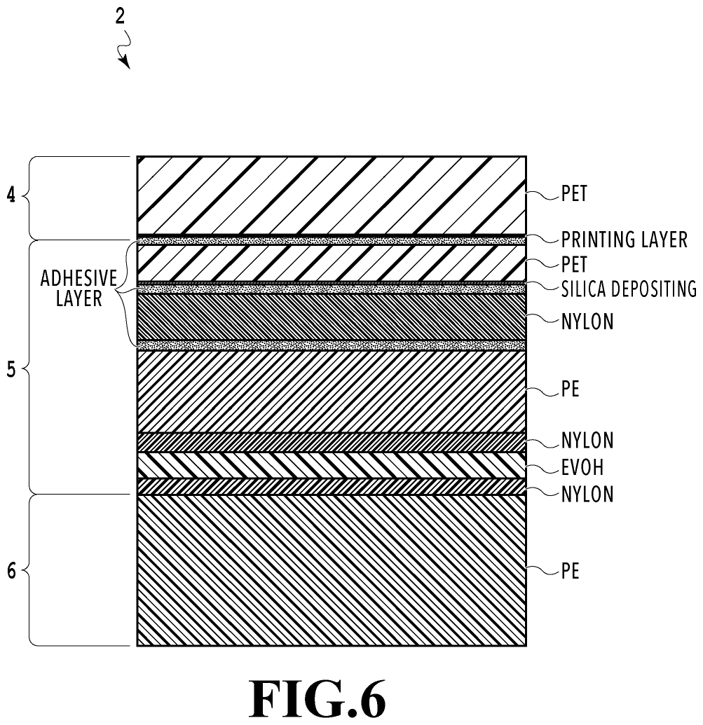

FIG. 6 is a cross-sectional view illustrating a film configuration of the ink accommodating unit 2 in the ink pack 1 in accordance with a fifth embodiment of the present disclosure. In the fifth embodiment, the intermediate layer 5 of the ink accommodating unit 2 includes a plurality of layers. The plurality of layers is a combination of a polyethylene terephthalate layer, a printing layer (ink receiving layer), a silica depositing layer, a nylon layer, a polyethylene layer, and an EVOH (ethylene vinyl alcohol copolymer resin) layer, but the order and the combination of the layers are not limited to this.

In the fifth embodiment, the outer layer 4 may be a PET film having a thickness of 25 μm or more and including the recycled plastic material. An outermost layer of the intermediate layer 5 may be a PET film including the recycled plastic material and have a thickness of 25 μm or more to maintain durability. The inner layer 6 may be a PE film including the recycled plastic material and having a thickness of 48 μm or more. Further, the inner layer 6 may be a film which includes the recycled plastic material and to which a water-repellent treatment is applied and is effective at finishing up an ink. Furthermore, in order to improve ink resistance, a fluorine sealant may be applied to a surface of the inner layer 6.

Therefore, any of the outer layer 4, the plurality of layers of the intermediate layer 5, and the inner layer 6 may be a nylon film including the recycled plastic material. Further, the nylon film used for any of the outer layer 4, the plurality of layers of the intermediate layer 5, and the inner layer 6 may be 15 μm or more in thickness. Furthermore, any of the outer layer 4, the plurality of layers of the intermediate layer 5, and the inner layer 6 may be a film created by biaxial stretching in order to improve the strength of an ink pack. The technique described in the present specification can contribute to the realization of the sustainable society such as the decarbonized/circular society.

### Other Embodiments

In the embodiments mentioned above, a form of an ink pack is described as an ink container, but the application of the present disclosure is not limited to this form. For example, the present disclosure may be applied to an ink container in which each surface of a case is composed of a film which has the configuration described in each embodiment mentioned above and which maintains a constant form which do not change according to the consumption of an ink even though the ink is consumed.

Further, the layer including the recycled plastic material has a lower degree of transparency compared with the virgin material thereof. For instance, the haze value of a layer in which the recycled plastic material is included in a PET film is about three times as much as that of a layer which includes only a PET film. The haze value indicates a value of transparency of an object, and as the haze value is larger, the object becomes more opaque. For example, clear glass has a haze value of 0%, but a plastic film has a haze value of 4% or the like.

According to the present disclosure, an ink container excellent in ink resistance can be provided even though the recycled plastic material is used for the ink container.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-082511 filed May 21, 2024, which is hereby incorporated by reference wherein in its entirety.

What is claimed is:

1. An ink container accommodating an ink to be supplied to an inkjet printing apparatus, the ink container comprising:
an ink accommodating unit formed of a plurality of layers and configured to accommodate the ink; and
an ink supply unit configured to supply the ink in the ink accommodating unit to an outside of the ink accommodating unit, wherein
at least one layer not in contact with the ink among the plurality of layers includes a recycled plastic material.

2. The ink container according to claim 1, wherein
the ink supply unit is formed of a plurality of layers, and at least one layer not in contact with the ink among the plurality of layers of the ink supply unit includes a recycled plastic material.

3. The ink container according to claim 1, wherein
the layers of the ink accommodating unit comprise an outer layer, an intermediate layer, and an inner layer; the intermediate layer is between the outer layer and the inner layer; and the intermediate layer includes the recycled plastic material.

4. The ink container according to claim 1, wherein
the layers of the ink accommodating unit comprise an outer layer, an intermediate layer, and an inner layer, the intermediate layer is between the outer layer and the inner layer, and the outer layer includes the recycled plastic material.

5. The ink container according to claim 1, wherein
the layers of the ink accommodating unit comprises an outer layer, an intermediate layer, and an inner layer; the intermediate layer is between the outer layer and the inner layer; and the inner layer includes the recycled plastic material;
the inner layer has a protective layer on a surface which is to contact the ink; and
the protective layer is a virgin material which is identical to a virgin material of the inner layer.

6. The ink container according to claim 5, wherein
a thickness of the protective layer is a thickness realized by a smaller amount of virgin material than an amount of virgin material which is decreased by using the recycled plastic material for the inner layer.

7. The ink container according to claim 3, wherein
the intermediate layer is formed of a plurality of layers, and any layer of the plurality of layers includes the recycled plastic material.

8. The ink container according to claim 7, wherein
the plurality of layers of the intermediate layer are at least one selected from the group consisting of a polyethylene terephthalate layer, a printing layer (ink receiving layer), a silica depositing layer, a nylon layer, a polyethylene layer, and an EVOH (ethylene vinyl alcohol copolymer resin) layer.

9. The ink container according to claim 2, wherein
the ink supply unit comprises a protective layer on a surface which is to contact the ink.

10. The ink container according to claim 9, wherein the protective layer includes silicone.

11. The ink container according to claim 10, wherein the protective layer includes an organo-modified silicone.

12. The ink container according to claim 1, wherein the layer including the recycled plastic material has a higher haze value compared with the layer including only a virgin material.

13. The ink container according to claim 1, wherein the ink container is a pillow type ink pack or a gusseted type ink pack.
